(19) United States
(12) Patent Application Publication
(10) Pub. No.: US 2005/0258606 A1
(43) Pub. Date: Nov. 24, 2005

(54) Chuck for fishing rod winding machines

(76) Inventor: Tsung-Seng Lee, Tainan City (TW)

Correspondence Address: BIRCH STEWART KOLASCH & BIRCH, PO BOX 747, FALLS CHURCH, VA, 22040-0747, US

(21) Appl. No.: 10/851,146

(22) Filed: May 24, 2004

(51) Int. Cl. B23B 31/16

(52) U.S. Cl. 279/114

(57) ABSTRACT

A chuck for fishing rod winding machines includes an anchor disk, jaws, a rotary ring, a clip ring and pliable caps. The anchor disk has three wedge troughs on one side and a recess on another side with a strut in the center extending outwards. The strut has tenons located on the peripheral surface at different diameters and an annular groove close to the front end to couple with the clip ring. The wedge troughs are coupled with jaws each has teeth on the bottom end to couple with a helical flange located on one side of the rotary ring. The anchor disk may be turned to drive the jaws to move inwards or outwards. The rotary ring may be turned in the opposite direction to enable the jaws to clamp a rod. The movement of the jaws may be fine tuned according to various types of rods.

### FIELD OF THE INVENTION

The present invention relates to a chuck of winding machines aims to securely clamp different sizes of handgrip ends of different rods.

### BACKGROUND OF THE INVENTION

The conventional method for winding a leather band on fishing rods, golf clubs, suspension rods, wooden rods or the like generally has to coat a layer of adhesive on the rods first. In operation, the common practice is to coat the adhesive while the fishing rod is turning. Although such an approach can coat the adhesive on the fishing rod, in practice it still has problems during assembly or use, notably:

1. The center cannot be aligned precisely:

The fishing rod mounted on the winding machine cannot be maintained on a straight line. Horizontal alignment mostly is accomplished through visual measurement. It is difficult to make precise horizontal calibration.

2. Turning of the rod is undesirable:

Users have to turn the fishing rod by hands. The force is not evenly applied and the angular movement of the fishing rod also is not even. As a result, the coated adhesive and the wound leather band also are not even.

### SUMMARY OF THE INVENTION

In view of the aforesaid disadvantages occurred to the conventional fishing rod winding machine, the primary object of the present invention is to provide a chuck of winding machines that has an anchor disk turnable clockwise and counterclockwise to move jaws coupled by teeth inwards or outwards, and a rotary ring coupled with the anchor disk turnable in a reverse direction to allow the jaws to securely clamp the handgrip end of different diameters of the rods so that fine tuning adjustment may be made according to various types of rods.

In another aspect, the invention provides a pliable cap to couple one side of the jaw so that it can clamp the handgrip end securely without causing damages and can increase life span of the jaw and clamp different sizes of handgrip of different rods.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the present invention.

FIG. 2 is an exploded view of the chuck of the present invention.

FIG. 3A is a perspective view of the chuck of the present invention.

FIG. 3B is a cross section taken on line 3B-3B in FIG. 3A.

FIG. 4A is a schematic view of the anchor disk of the present invention in a turning condition.

FIG. 4B is a schematic view of the anchor disk of the present invention in a turning condition for moving the jaws outwards.

FIG. 5 is a schematic view of the rotary ring and the anchor disk of the present invention turning in different directions to clamp the rod.

FIG. 6 is a perspective view of the chuck of the invention in use for clamping the handgrip end of a rod.

FIG. 7 is a schematic view of another embodiment of the pliable cap of the invention.

FIGS. 8A and 8B are schematic views of the invention showing the pliable caps in moving conditions.

### DETAILED DESCRIPTION OF THE PREFERRED EMBODIMENTS

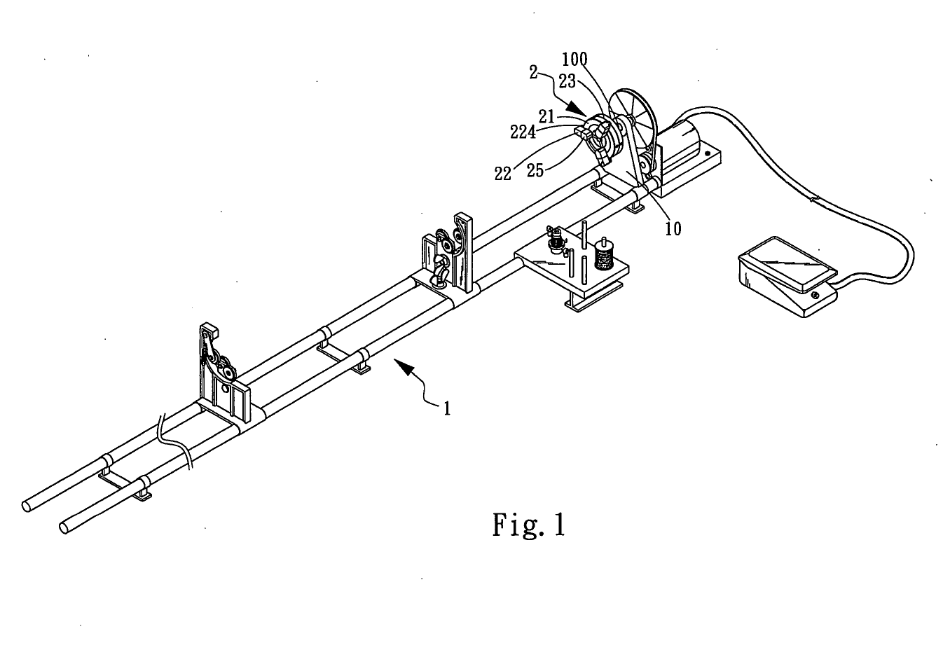

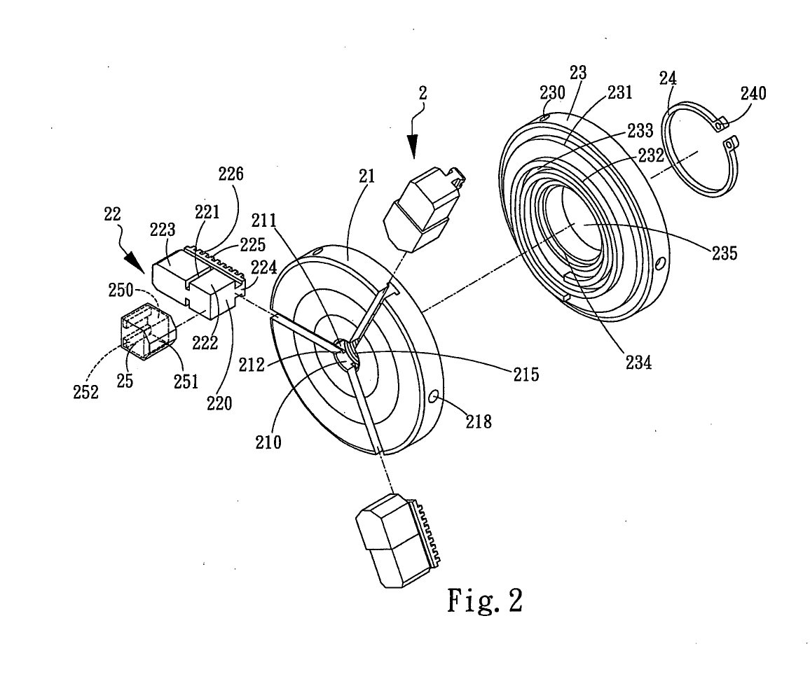

Please referring to FIGS. 1 and 2, the present invention includes a chuck dock 10 located on one end of a fishing rod winding machine 1 that has a shaft 100 pivotally coupled with a chuck 2. The chuck 2 includes an anchor disk 21, jaws 22, a rotary ring 23, a clip ring 24 and pliable caps 25.

The anchor disk 21 is circular and has a round opening 210 in the center on one side, and three wedge troughs 211 extended radially outwards from the round opening 210. Each wedge trough 211 has two parallel flanges 212 on two sides. The chuck disk 21 further has a recess 213 formed on another side. There is a strut 214 extended outwards from the center of recess 213. The strut 214 has a screw hole 215 which is co-axial with the round opening 210 that communicate with each other. The peripheral surface of the strut 214 has tenons 216 formed thereon from inside to outside at different diameters and an annular groove 217. The peripheral rim of the anchor disk 21 further has three round holes 218 to receive a tool for turning.

Each jaw 22 has a flat surface 220 on a front side and two flutes 221 on two opposite sides close to the front end to divide the jaw 22 in a front section 222 and a rear section 223. The flutes 221 may be coupled with corresponding ridges 252 formed on a pliable cap 25. The bottom side of the jaw 22 has a wedge neck 224 matching with the wedge trough 211 that has a plurality of arched teeth 225 formed on the bottom end spaced by the same interval 226.

The rotary ring 23 has round holes 230 formed on the perimeter to engage with tools for turning. It has a collar 231 extended from one side to wedge in the recess 213 of the anchor disk 21 to become one body. The collar 231 has a top surface with a helical flange 232 formed thereon that extends gradually from inside to outside. The helical flange 232 is bordered by a helical trough 233 to engage with the arched teeth 225 of the jaw 22. The collar 231 has an indented surface 234 and a bore 235 in the center to couple with the tenons 216 of the strut 214 to become one body. Thus the anchor disk 21 and the rotary ring 23 may be wedged and coupled together without deviating or loosening off.

The clip ring 24 is annular and made from elastic material and has latch members 240 on two ends.

Each pliable cap 25 has a cavity 250 to couple with the front section 222 of the jaw 22 and a conical section 251 on one side and the opposing ridges 252 on another side corresponding to the flutes 221 of the jaw 22.

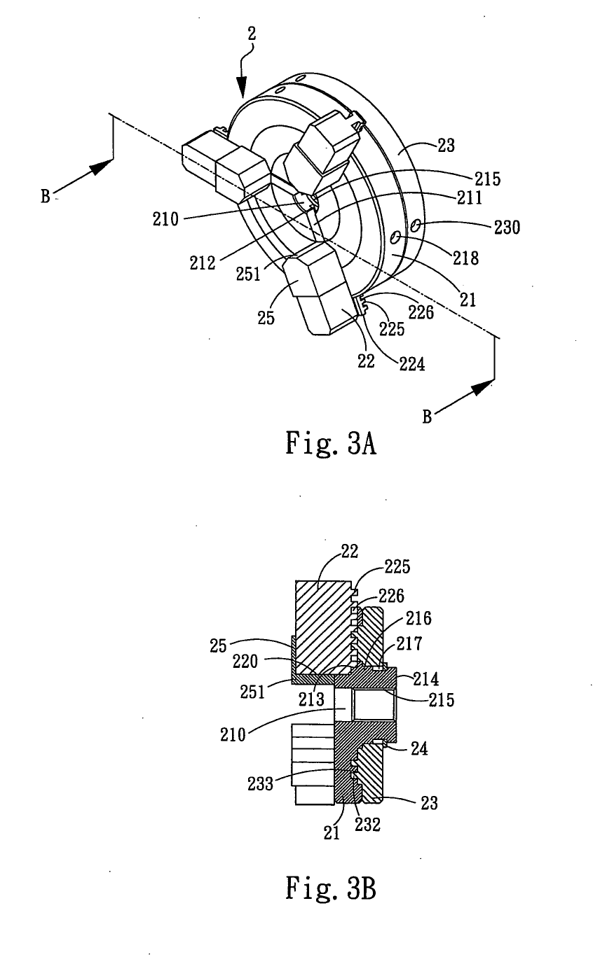

By means of the construction set forth above, when the anchor disk 21 is coupled with the rotary ring 23, the teeth 225 may be wedged in the trough 233, and the tenons 216 of the strut 214 may be coupled with the indented surface 234 to enable the strut 214 to run through the bore 235, then the clip ring 24 may be wedged in the annular groove 217 of the strut 214 so that the rotary ring 23 may be coupled with the anchor disk 21 to become one body (referring to FIGS. 3A and 3B).

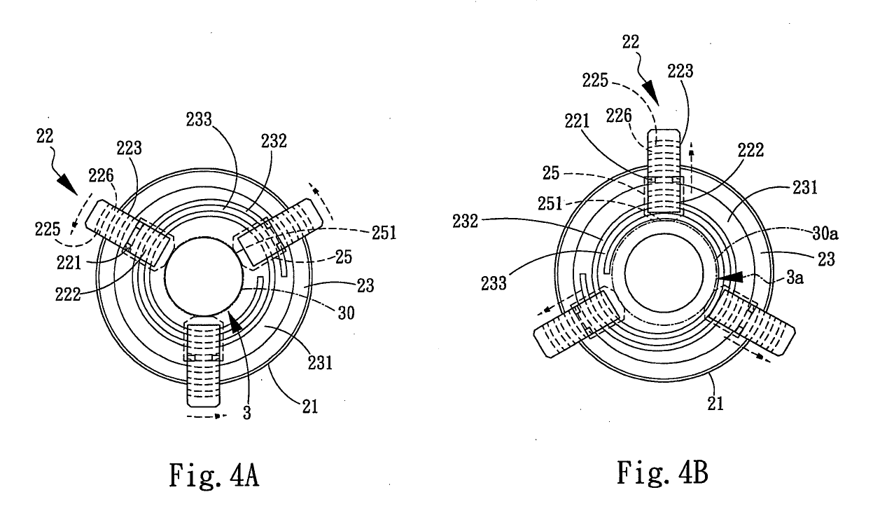

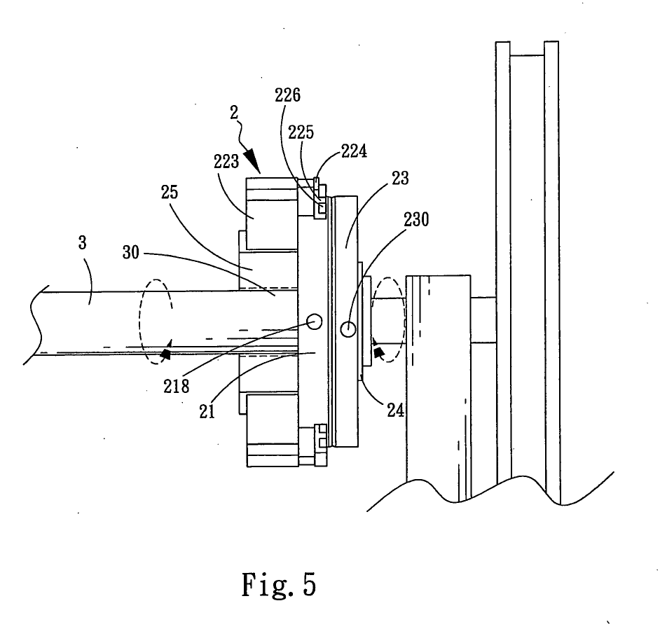

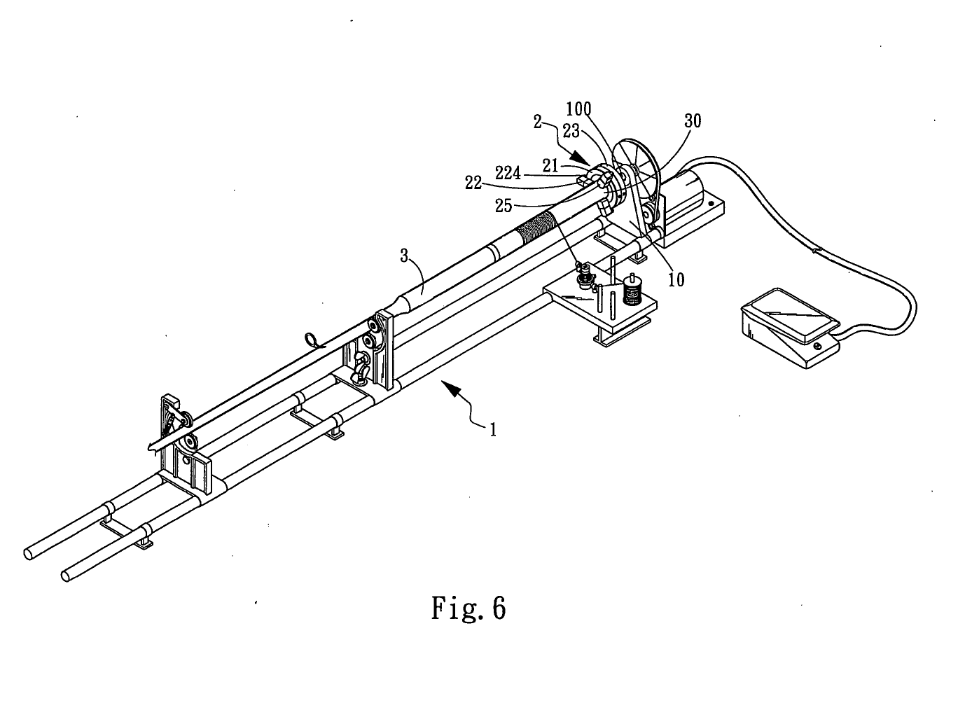

Referring to FIG. 4A, depending on the diameter of the handgrip ends 30 and 30a of rods 3 and 3a, the chuck may be adjusted by first inserting a tool into the round hole 218 of the anchor disk 21 and turning the anchor disk 21 counterclockwise (or clockwise); the interval 226 of the jaw 22 may be wedged with the helical flange 232, while the teeth 225 of the jaw 22 is wedged in the trough 233, so that the jaw 22 may be moved gradually from inside to outside (referring to FIG. 4) (or from outside to inside) while the anchor disk is turning; the rotary ring 23 may be turned in the opposite direction to clamp the handgrip ends 30 and 30a of the rods 3 and 3a (referring to FIG. 5). The conical section 251 of the pliable cap 25 presses the handgrip ends 30 and 30a (referring to FIG. 6) to anchor the rods 3 and 3a on three points. Hence the rods 3 and 3a may be maintained on the same horizontal line for winding a band and coating adhesive evenly.

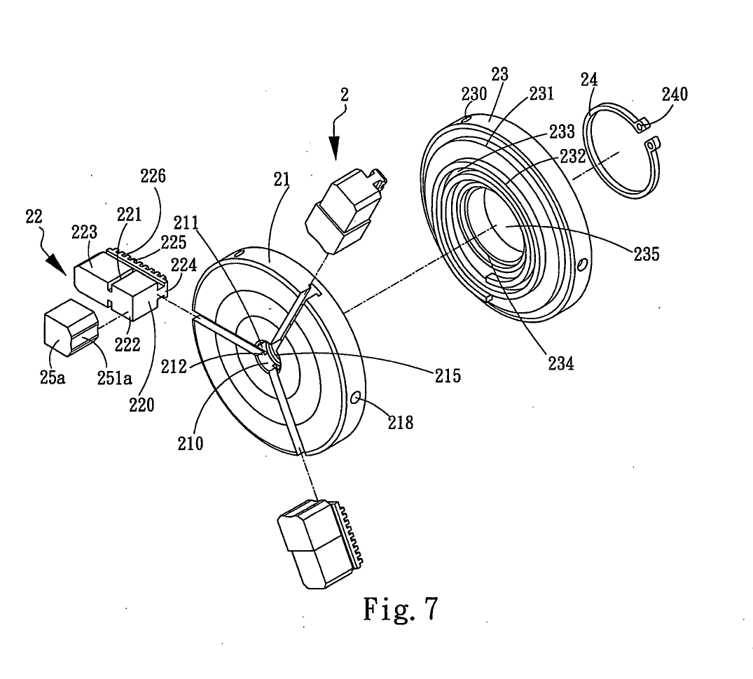

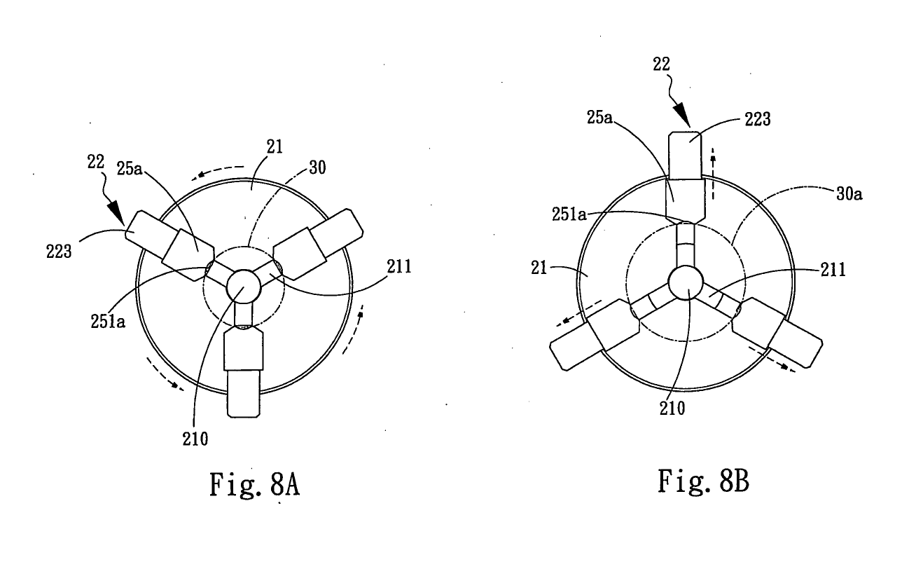

Referring to FIG. 7, one end of the pliable cap 25a may also be formed with a concave bucking edge 251a to form a secure clamping on the handgrip ends 30 and 30a when the jaws 22 are driven by the helical flange 232 and the anchor disk 21 is turned counterclockwise (or clockwise) (referring to FIGS. 8A and 8B).

In summary, the chuck according to the invention has a collar 231 on the rotary ring 23 to be coupled in the recess 213 of the anchor disk 21, and the collar 231 has a helical flange 232 on one side to wedge in the interval 226 of the teeth 225 of the jaws 22 so that when the anchor disk 21 is turned clockwise or counterclockwise, the helical flange 232 of the rotary ring 23 can move the jaws 22 from inside to outside, or from outside to inside to securely clamp the handgrip ends 30 and 30a of the rods 3 and 3a. As the jaws 22 may be moved in a fine-tuned manner, clamping damage of the handgrip ends 30 and 30a may be prevented.

1. A chuck for a fishing rod winding machine having a chuck dock located on one end of the fishing rod winding machine that has a shaft coupling with a chuck, the chuck comprising an anchor disk, jaws, a rotary ring, a clip ring and pliable caps, wherein:
the anchor disk has a round opening in the center on one side, three wedge troughs extended radially outwards from the round opening, a recess formed on another side, and a strut extended outwards from the center of recess;
each of the jaws has a flat surface on a front end, two flutes formed on two opposite sides close to the front end to divide the jaw in a front section and a rear section, and a wedge neck extended from the bottom thereof;
the rotary ring has a collar extended from one side that has a top surface with a helical flange formed thereon that extends gradually from inside to outside;
the clip ring has latch members on two ends; and
each of the pliable cap having a cavity to couple with the front section of the jaw;
wherein the anchor disk is coupled with the rotary ring and turnable counterclockwise or clockwise, the jaws being engaged with the rotary ring and movable from inside to outside or from outside to inside when the rotary ring is turned in an opposite direction of the anchor disk to securely clamp handgrip ends of varying diameters of rods.

2. The chuck for a fishing rod winding machine of claim 1, wherein the wedge trough has parallel flanges on two sides.

3. The chuck for a fishing rod winding machine of claim 1, wherein the strut has a screw hole formed therein.

4. The chuck for a fishing rod winding machine of claim 3, wherein the screw hole and the round opening are co-axial and communicate with each other.

5. The chuck for a fishing rod winding machine of claim 3, wherein the strut has tenons located on an inner side of the periphery at different diameters and an annular groove close to an outer side thereof.

6. The chuck for a fishing rod winding machine of claim 1, wherein the anchor disk is circular and has round holes formed on the peripheral rim to receive tools for turning the anchor disk.

7. The chuck for a fishing rod winding machine of claim 1, wherein the wedge neck has arched teeth on the bottom end spaced from one another by a same interval.

8. The chuck for a fishing rod winding machine of claim 1, wherein the collar has an indented surface and a bore in the center.

9. The chuck for a fishing rod winding machine of claim 1, wherein the pliable cap has a conical section on one side and wedging ridges on another side opposing each other.

10. The chuck for a fishing rod winding machine of claim 1, wherein the pliable cap has a concave bucking edge on one side.
